(19) United States
(12) Patent Application Publication
(10) Pub. No.: US 2018/0330396 A1
(43) Pub. Date: Nov. 15, 2018

(54) DISTRIBUTED IMAGE-BASED ACQUISITION SYSTEM

(71) Applicant: Wal-Mart Apollo, LLC, Bentonville, AR (US)

(72) Inventors: Shawn Dawson Branham, Bentonville, AR (US); Richard Montgomery Blair, II, Bentonville, AR (US); Jacob Tucker, Bella Vista, AR (US); Dane C. Erickson, Bentonville, AR (US)

(21) Appl. No.: 15/974,275

(22) Filed: May 8, 2018

Related U.S. Application Data
(60) Provisional application No. 62/503,694, filed on May 9, 2017.

(51) Int. Cl. G06Q 30/02; G06K 7/14; G06K 9/00

(52) U.S. Cl. CPC G06Q 30/0234; G06Q 30/0235; G06K 2007/10524; G06K 7/1413; G06K 9/00442; G06Q 30/0225

(57) ABSTRACT

Exemplary embodiments are related to image-based acquisition systems and methods. An image-based acquisition system identifies one or more items in one or more receipts of previous transactions that are associated with one or more coupons received by the system through a mobile application, and automatically applies a credit associated with the one or more coupons to the user account based on the identified one or more items. The image-based acquisition system further automatically identifies one or more items that are associated with one or more coupons received via the mobile application and available for sale, and automatically adds the one or more items to an existing or new online order for a user associated with the user account.

### RELATED APPLICATION

This application claims priority to, and the benefit of, U.S. Provisional Patent Application No. 62/503,694, filed May 9, 2017, entitled “Distributed Image-Based Acquisition System”, the contents of which are incorporated herein by reference in their entirety.

### BACKGROUND

Today's mobile computing devices, such as smartphones, are frequently equipped with a number of different sensing technologies in addition to communication capabilities. For example, most smartphones are equipped with cameras and the ability to scan bar codes. The data acquired by the mobile devices may be sent to remote locations for further processing.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram showing an image-based acquisition system in accordance with an exemplary embodiment.

FIG. 2 is a flow diagram illustrating a method performed by an image-based acquisition system in accordance with an exemplary embodiment.

FIG. 3 is a flow diagram illustrating a method performed by an image-based acquisition system in accordance with another exemplary embodiment.

FIG. 4 is a flow diagram illustrating an example process for uploading and applying coupons at a user terminal performed by the image-based acquisition system in accordance with an exemplary embodiment.

FIG. 5 is a flow diagram illustrating an example process for applying coupons at retail establishments performed by the image-based acquisition system in accordance with an exemplary embodiment.

FIG. 6 is a block diagram of an exemplary computational device with various components which can be used to implement various embodiments.

FIG. 7 is block diagram of an exemplary distributed system suitable for use in exemplary embodiments.

### DETAILED DESCRIPTION

Methods and systems are provided herein for processing machine-readable coupons utilizing a mobile application integrated into a distributed image-based acquisition system that can access a user's account according to the user's profiles. The image-based acquisition system, in accordance with various embodiments, is configured to upload coupons scanned by a user with the mobile application, determine whether the coupons are valid and link the valid coupons to the user's account. In one embodiment, if a user wants to redeem a coupon retroactively, the image-based acquisition system is further configured to upload an image of a receipt of a previous transaction via the mobile application, and apply all the applicable, valid, and unused coupons associated with the user's account to the items represented in the previous transaction. A discount value associated with the coupon can be awarded as a reimbursement, for example, in the form of a gift card associated to the user's account. In another embodiment, the uploading of a validated coupon may automatically trigger the addition of a corresponding item referred to by the coupon to an online order associated with the user. The order may be a new order or an existing order. In another embodiment, the image-based acquisition system compiles all the scanned and valid coupons in the user's account into a single machine-readable barcode which can be forwarded to the user's device to be scanned at a checkout location so that all the applicable coupons can be applied to the purchase immediately with a single scan.

The systems and methods provided herein are able to advantageously reduce the need for separate network requests from a user by automatically triggering the addition of an item to a new or existing online order as a result of the act of uploading a valid coupon via the mobile application. Further, the system saves network processing time associated with a checkout in a facility by consolidating multiple coupons into a single machine-readable barcode such that all the applicable coupons can be redeemed at checkout in a single scan. This reduces the time spent on validating and scanning coupons at the register. Further, the coupon data is associated with the users' account in the system which allows the system to apply coupons to a purchase retroactively for past receipts uploaded via the mobile application to the user's account. The coupon value is added to the user account balance and is redeemable, for example, as an E-Gift card or some other manner indicated in a user's stored profile. The automatic application of the discount to items in the past receipt by the image-based acquisition system further limits the amount of network communication required by the system with the user's mobile device.

Accordingly, systems and methods provided herein allow the users to upload coupons to their account at their convenience and apply coupons to a past purchase; systematically validate and digitally authenticate coupons according to the coupon policy; remove the physical need for coupons and compile all digitally stored coupons to a single scannable barcode rendered on a mobile device that enables applying multiple coupons with a single scan. The coupons can be linked to an individual's account via their account email address and can be redeemable either in-person at a POS system or remotely through the distributed image-based acquisition system.

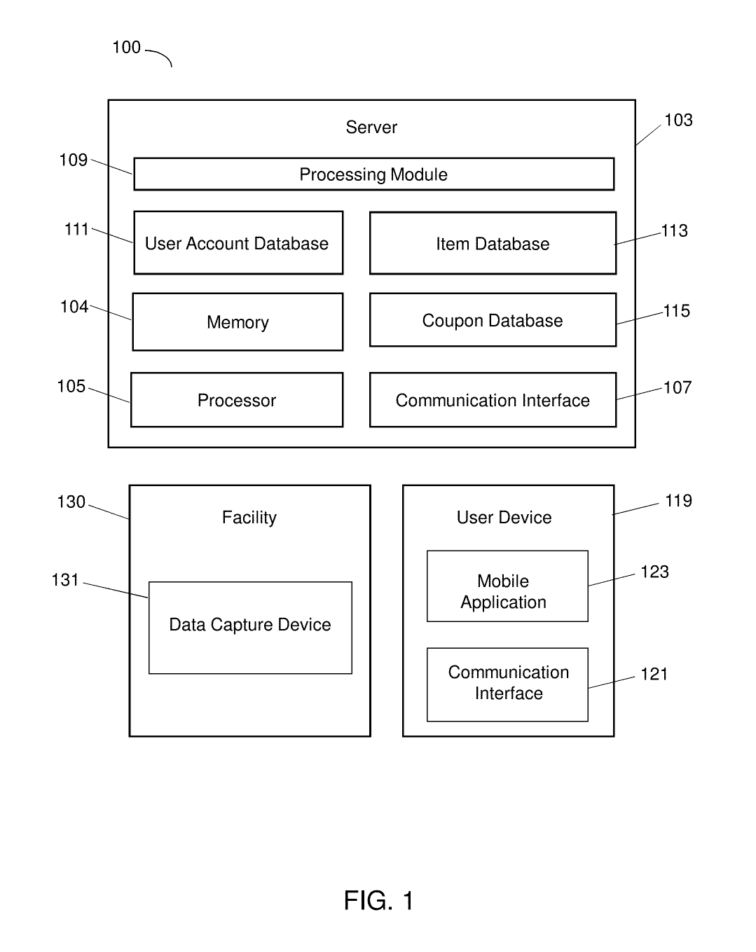

Referring now to FIG. 1, an exemplary distributed image-based acquisition system 100 includes a server 103. The server 103 includes memory 104, a processor 105 and communication interface 107. The server is configured to execute a processing module 109 and also includes or is able to access a user account database 111, item database 113, and coupon database 115. The processing module 109 makes use of the communications interface 107 to receive transmitted coupon data from a mobile application 123 executing on a mobile user device 119. The processing module 109 is configured to determine the validity of the received coupons, compile multiple coupons into a single coupon with a scannable barcode and return it to a user device, and apply coupons to past purchases. The user account database 111 includes information associated with each user account, such as an email address, a user's previous purchase information, a user's existing shopping list, etc. The item database 113 includes information regarding items available for sale. The coupon account database 115 includes information associated with individual coupons, such as a qualified item code, a coupon redemption value, a coupon validity period and/or expiration date, etc.

Communication interface 107, in accordance with various embodiments can include, but is not limited to, a radio frequency (RF) receiver, RF transceiver, NFC device, a built-in network adapter, network interface card, PCMCIA network card, card bus network adapter, wireless network adapter, USB network adapter, modem or any other device suitable for interfacing with any type of network capable of communication and performing the operations described herein. Processor 105, in accordance with various embodiments can include, for example, but not limited to, a microchip, a processor, a microprocessor, a special purpose processor, an application specific integrated circuit, a microcontroller, a field programmable gate array, any other suitable processor, or combinations thereof. Server 103 may also include, memory (not shown) such a but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

User device 119 includes communication interface 121 for communicating with the server 103 and executes a mobile application 123. User device 119 may be smartphone, tablet or other mobile device equipped with a processor, mobile application 123 and communication interface 121. The mobile application 123 can generate a user interface for accepting user input and is configured to control an integrated data acquisition device such as, but not limited to, a camera on user device to capture images of coupons and, in one embodiment, images of purchase transaction information on a purchase receipt. Mobile application transmits the captured images via communication interface 121 to processing module 109 on server 103. Processing module analyzes the received images to extract bar codes and the bar codes associated data from images of coupons. The extracted data is used to query coupon database 115 to determine coupon validity. Valid coupons may be associated with the user in user account database 111. Processing module 109 may also analyze received images to extract item data from uploaded receipts of past transactions. The item information may be stored in user account database 111 or another database. The extracted item information may also be compared to contemporaneously uploaded or previously stored coupon information in user account database 111 and credits applied to the user account in the event of a match.

The user device 119 can then be used to automatically associate the coupon data and the purchase transaction information with the user account or permit the user to manually associate the coupon data and the purchase transaction information with the user account via the user interface 121 of the user device 119. The data capture device 123, in accordance with various embodiments, can capture the purchase transaction information from any relevant portion of the receipt, including for example, the header information, trailer information, line level details, unique transaction codes (e.g., one or more of printed characters, a bar code, or a QR code), or combinations thereof.

In accordance with various embodiments, the data capture device 123 can capture the images of coupons and receipts of previous purchases, and then the captured images are transmitted from the user device 119 to the server 103. Upon receiving the coupon data and receipt data at the communications interface 107, the server 103 verifies whether the coupon is valid for the purchase associated with the receipt and can automatically apply the valid coupons to the previous purchase. Further, the system can automatically add the item associated with the valid coupon to an existing order associated with the user account, or to a new order initiated by the system.

In one embodiment, processing module may transmit a coupon with a cumulative barcode representing all of the coupons associated with the user account to user device 119. User device may display the barcode via a display screen to a data capture device 131 in a facility 130 such as a retail location when shopping. In accordance with various embodiments, when the user makes a purchase at a retail location, data capture device 131 can be but is not limited to, a point of sale terminal (POS) having a barcode scanner and an optional credit card reader. The user or cashier can use the barcode reader to scan the cumulative barcode being displayed by mobile application 123. Data capture device 131 may transmit the data from the cumulative bar code over a network to processing module 109 which may provide coupon data for the individual coupons associated with the cumulative bar code back to data capture device 131 which may then match applicable coupons to purchased items as if the coupons had been individually scanned at the data capture device.

Data capture device 131 can be any device suitable for acquiring and/or transmitting machine-readable coupon data, including for example, a barcode scanners, an RFID reader, a NFC reader, a barcode reader, a digital camera, a mobile device, a magnetic strip reader, a point of sale terminal, any other suitable device, or combinations thereof. In accordance with various embodiments, data capture device 131 can include an integral transmitter or transceiver for transmitting the acquired coupon data to processing module 109.

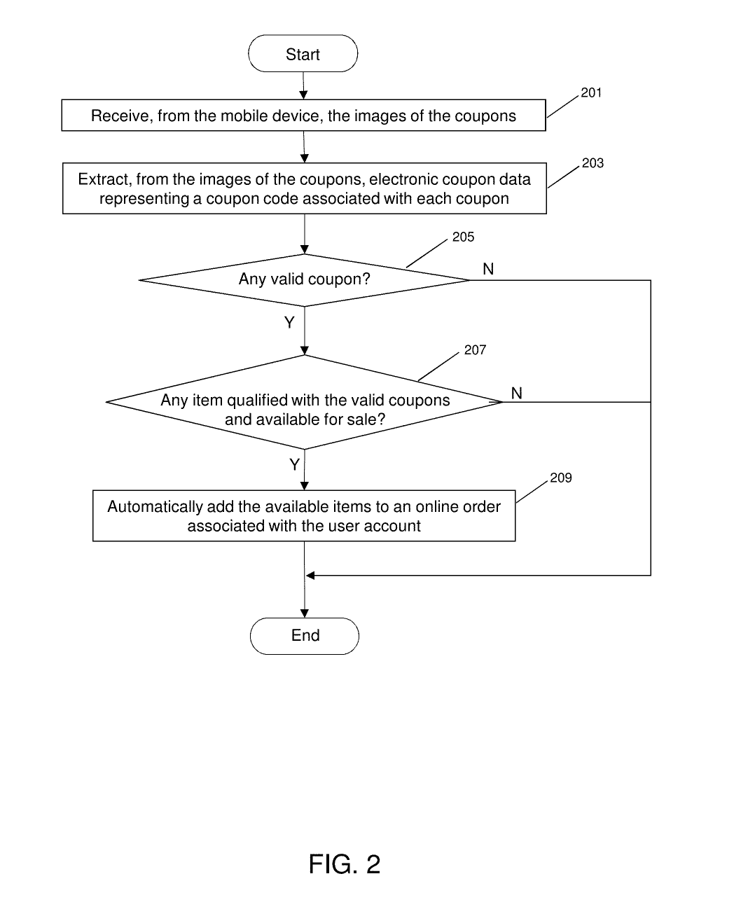

FIG. 2 is a flow diagram illustrating a method performed by an image-based acquisition system in accordance with an exemplary embodiment that initiates or supplements an existing online order. At step 201, a processing module on a computing system associated with a retail entity receives images of the one or more coupons from a mobile application executing on a user mobile device. The mobile application is associated with a user account. The processing module extracts electronic coupon data that represents a coupon code associated with each coupon from the images of the coupons at step 203. The coupon code can include, for example, but is not limited to, a qualified item code indicating that this coupon can be applied to a particular qualified item, a coupon redemption value indicating the amount that can be reduced from the receipt total, and an expiration date indicating when the coupon will expire.

At step 205, the processing module determines whether each of the received coupons is valid based on the electronic coupon data and the coupon policies of the retail establishment. For example, the processing module may query a coupon database using a coupon identifier extracted from the image of the coupon. The system can further determine whether the coupon is expired based on the expiration date and a current date for the coupon listed in the coupon database. If none of the coupons are valid, the process ends. If some of the coupons are determined as valid at step 205, the processing module further determines whether there is any item qualified for the valid coupons and available for sale by the retail entity at step 207. For example, the processing module may query an item database containing information regarding available items using the identity of the item associated with the extracted coupon code. If no items are available, the process ends. Otherwise, if there are items determined to be qualified for the coupons and available for sale at step 207, the system automatically adds the identified available qualified items to an existing online order associated with the user account, or the system initiates a new order for the user and add the available qualified items to the new order at step 209. In this manner, the mere scanning of coupons by the mobile application automatically triggers the creation of a new online order or the automatic addition to a pending online order. In one embodiment, the distributed image-based acquisition system can notify the user of the online order additions and a redemption value of the coupons as applied to the order through the mobile application.

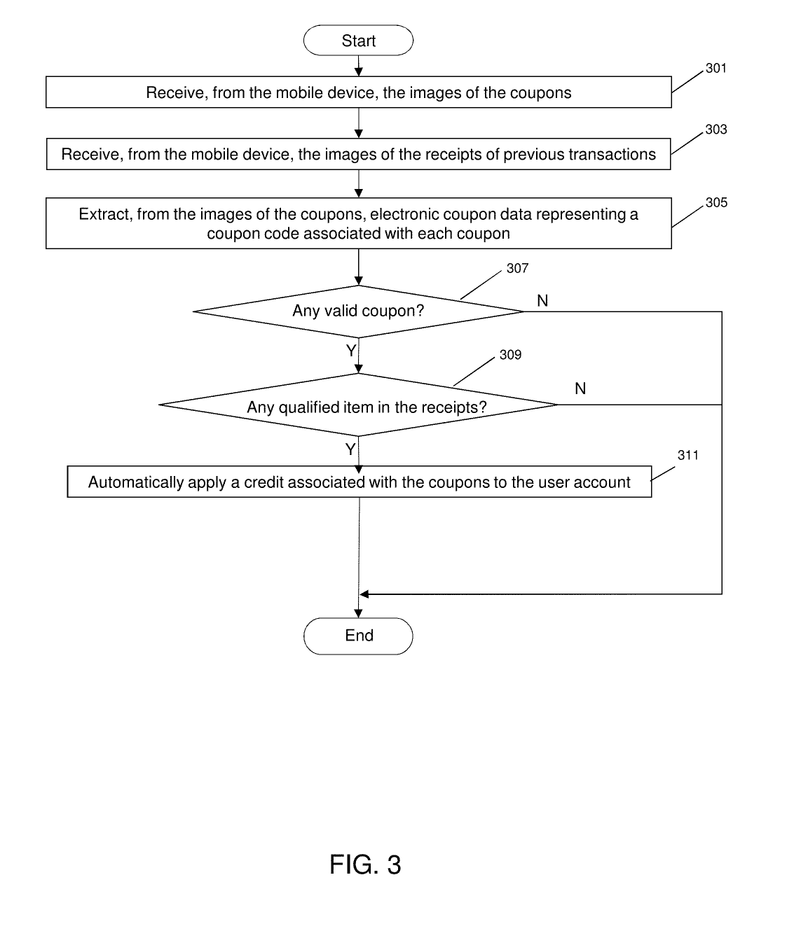

FIG. 3 is a flow diagram illustrating a method performed by an image-based acquisition system in accordance with another exemplary embodiment to credit a user for a past transaction. A processing module being executed on a computing system receives images of one or more coupons from a mobile application executing on a user's mobile device at step 301. The mobile application is associated with a user account. The processing module also receives images of one or more receipts of previous transactions from the mobile application at step 303. At step 305, the processing module extracts electronic coupon data that represents a coupon code associated with each coupon from the images of the coupons. The coupon code may include, but is not limited to, a qualified item code indicating that this coupon can be applied to a particular qualified item, a coupon redemption value indicating the amount that can be reduced from the receipt total, and an expiration date indicating when the coupon will expire.

At step 307, the system determines whether each of the received coupons is valid based on the electronic coupon data and the coupon policies of the retail establishment. For example, the processing module may query a coupon database using a coupon identifier extracted from the image of the coupon. If there is no valid coupon, the process ends. If at least some of the coupons are determined as valid at step 307, the system further determines whether there are any items listed in the receipts that match the valid coupons at step 309. For example, the processing module can extract electronic item data representing an item code associated with each item listed on the receipt, and determine whether the item is a qualified item based on the item data and the qualified item code included in the coupon code of each valid coupon. If there is no qualified item listed in the receipt, the process.

If it is determined that there are qualified items in the receipts, the processing module automatically applies a credit to the user account for the identified items according to the coupon redemption value of the valid coupon associated with the identified items at step 311, such that a receipt total of the receipt is reduced by the coupon redemption value, and then the process ends. The user associated with this user account can be notified when the credit is applied. For example, the credit can be applied in the form of a gift card dispensed to the user associated with the user account. It will be appreciated that other forms of credit are also within the scope of the present invention.

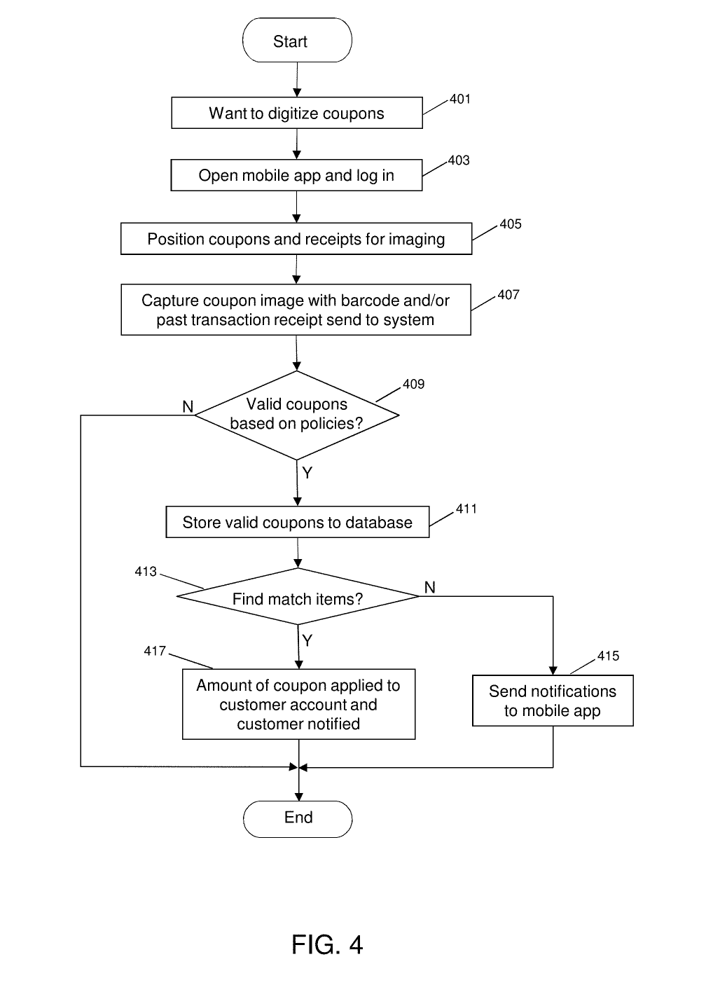

FIG. 4 illustrates an exemplary process for uploading and applying coupons to past receipts in accordance with an exemplary embodiment. When the user wants to digitize and upload coupons at step 401, the user can open the mobile application at the user device and log into his/her account at step 403. The user can position the coupons and/or past receipts for imaging at step 405, and then at step 407 an image of the coupon and its barcode can be captured via a camera in the mobile device. The mobile application sends the captured image(s) to a processing module on a remote computing system. In one embodiment, the user may also use the mobile application and the mobile device camera to capture an image of a past receipt containing item information related to a previous transaction which may also be forwarded to the processing module. As previously discussed, the mobile application may use the camera to capture an image of the coupon and its barcode and the barcode may be forwarded to, and processed at, the processing module on the remote server. In an alternative embodiment, the mobile device may have a built in scanner which may process the barcode to extract data and the extracted data may be sent by the mobile application to the processing module instead of forwarding the entire image. When the image is forwarded to the processing module, at step 409 the processing module determines whether the received coupons are valid coupons according to the coupon policies of the retail establishment. For example, the processing module may query the coupon database to retrieve validity information associated with a coupon code extracted from the image. If none of the coupons are valid, the process ends. If the coupons are determined to be valid based on the coupon policies, at step 411 the valid coupons can be stored to the coupon database.

At step 413, the processing module determines whether there are any items, which are included in the previous purchase receipts associated with the user's account, whether previously uploaded or uploaded in parallel with the coupons that match the item information of the valid coupon. If not, at step 415 the system can send “no match” notifications to the mobile application on the user mobile device and the process ends.

If at step 413 the system determines that some items in the receipts match the item information of the coupons, at step 417 the value of the valid coupon can be credited to the user's account, and the system may send notifications to the mobile application indicating there are qualified items to which the credit has been applied. The credit may be in the form of a gift card sent to the user, an automatic cash transfer to a previously registered band account, a credit to a previously registered credit card, or in some other manner.

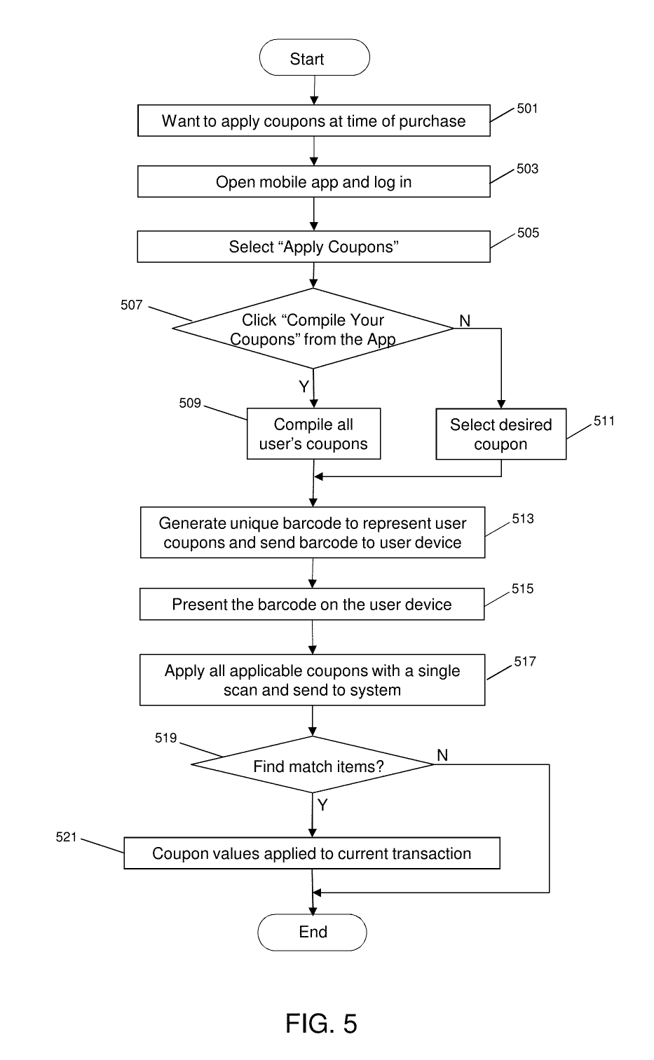

FIG. 5 illustrates an example process for applying previously stored coupons associated with a user's account to transactions at retail establishments performed by the image-based acquisition system in accordance with an exemplary embodiment. In the retail establishment, when the user wants to apply coupons at purchase at step 501, the user can open the mobile application and log in at step 503, and select the function “Apply Coupons” via the mobile application at step 505. At step 507, the mobile application may provide an option to click the function “Compile Your Coupons”. If the user clicks “Compile Your Coupons”, at step 509, all the coupons, or a portion of the coupons associated with the user account and stored in the user account database can be compiled by a processing module into a single coupon. At step 513 a unique single barcode can be generated to represent all of the user's coupons, and the generated barcode can be sent to a mobile application on a user device associated with the user account.

Referring back to step 507, if the user does not want to compile all the coupons, the user can select the desired coupons at step 511, and then at step 513 a unique barcode is generated to represent the selected coupons, and the generated barcode can be sent to the mobile application on a user device associated with the user account. At step 515, the generated barcode can be presented on the user device via a display. As a non-limiting example the barcode may be displayed on the display screen of the user's smartphone. Then at step 517, at the register of the retail establishment, a data capture device, for example, but not limited to, a point of sale terminal (POS) having a barcode scanner and an optional credit card reader, can scan the code to determine all the applicable coupons with a single scan. The data capture device sends the code to the processing module on the remote server. The processing module queries the coupon database using the code and returns a list of items associated with the code to the data capture device.

At step 519, the data capture device in the retail facility determines whether there are any items which are included in the current purchase that match the item information of the valid coupon. If not, the process ends.

If at step 521 the data capture device determines that some items in the current purchase match the item information of the coupons, at step 521 the value of the applicable coupons is applied to the current transaction.

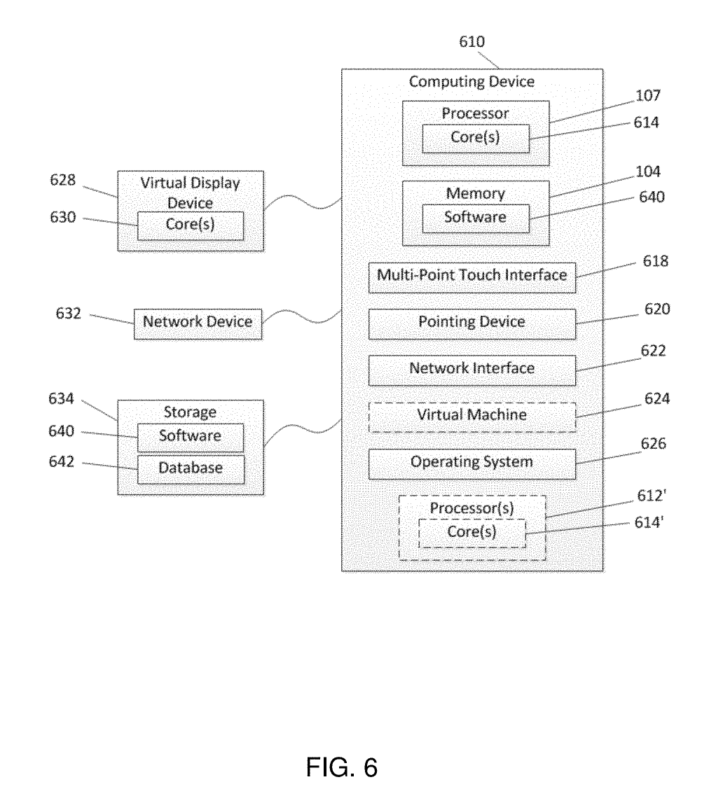

FIG. 6 is a block diagram of an exemplary computing device 610 such as can be used, or portions thereof, in accordance with various embodiments and, for clarity, refers back to and provides greater detail regarding various elements of the system 100 of FIG. 1. The computing device 610, which can be, but is not limited to the server, user mobile device and data capture device described herein, can include one or more non-transitory computer-readable media for storing one or more computer-executable instructions or software for implementing exemplary embodiments. The non-transitory computer-readable media can include, but not limited to, one or more types of hardware memory, non-transitory tangible media (for example, one or more magnetic storage disks, one or more optical disks, one or more flash drives), and the like. For example, memory 104 included in the computing device 610 can store computer-readable and computer-executable instructions or software for performing the operations disclosed herein. For example, the memory 104 can store a software application 640 which is configured to perform the disclosed operations (e.g., validate the coupons and apply valid coupons to purchases). The computing device 610 can also include configurable and/or programmable processor 107 and an associated core 614, and optionally, one or more additional configurable and/or programmable processing devices, e.g., processor(s) 612′ and associated core(s) 614′ (for example, in the case of computational devices having multiple processors/cores), for executing computer-readable and computer-executable instructions or software stored in the memory 104 and other programs for controlling system hardware. Processor 107 and processor(s) 612′ can each be a single core processor or multiple core (614 and 614′) processor.

Virtualization can be employed in the computing device 610 so that infrastructure and resources in the computing device can be shared dynamically. A virtual machine 624 can be provided to handle a process running on multiple processors so that the process appears to be using only one computing resource rather than multiple computing resources. Multiple virtual machines can also be used with one processor.

Memory 104 can include a computational device memory or random access memory, such as DRAM, SRAM, EDO RAM, and the like. Memory 104 can include other types of memory as well, or combinations thereof.

A user can interact with the computing device 610 through a visual display device 628, such as any suitable device capable of rendering texts, graphics, and/or images including an LCD display, a plasma display, projected image (e.g. from a Pico projector), Google Glass, Oculus Rift, HoloLens, and the like, and which can display one or more user interfaces 630 that can be provided in accordance with exemplary embodiments. The computing device 610 can include other I/O devices for receiving input from a user, for example, a keyboard or any suitable multi-point touch (or gesture) interface 618, a pointing device 620 (e.g., a mouse). The keyboard 618 and the pointing device 620 can be coupled to the visual display device 628. The computing device 610 can include other suitable conventional I/O peripherals.

The computing device 610 can also include one or more storage devices 634, such as a hard-drive, CD-ROM, flash drive, or other computer readable media, for storing data and computer-readable instructions and/or software that perform operations disclosed herein. In some embodiments, the one or more storage devices 634 can be detachably coupled to the computing device 610. Exemplary storage device 634 can also store one or more software applications 640 for implementing processes of the coupon processing system described herein and can include databases 642 for storing any suitable information required to implement exemplary embodiments. The databases can be updated manually or automatically at any suitable time to add, delete, and/or update one or more items in the databases. In some embodiments, at least one of the storage device 634 can be remote from the computing device (e.g., accessible through a communication network) and can be, for example, part of a cloud-based storage solution.

The computing device 610 can include a network interface 622 configured to interface via one or more network devices 632 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 622 can include a built-in network adapter, network interface card, PCMCIA network card, card bus network adapter, wireless network adapter, USB network adapter, modem or any other device suitable for interfacing the computing device 610 to any type of network capable of communication and performing the operations described herein. Moreover, the computing device 610 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 610 can run operating systems 626, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 626 can be run in native mode or emulated mode. In an exemplary embodiment, the operating system 626 can be run on one or more cloud machine instances.

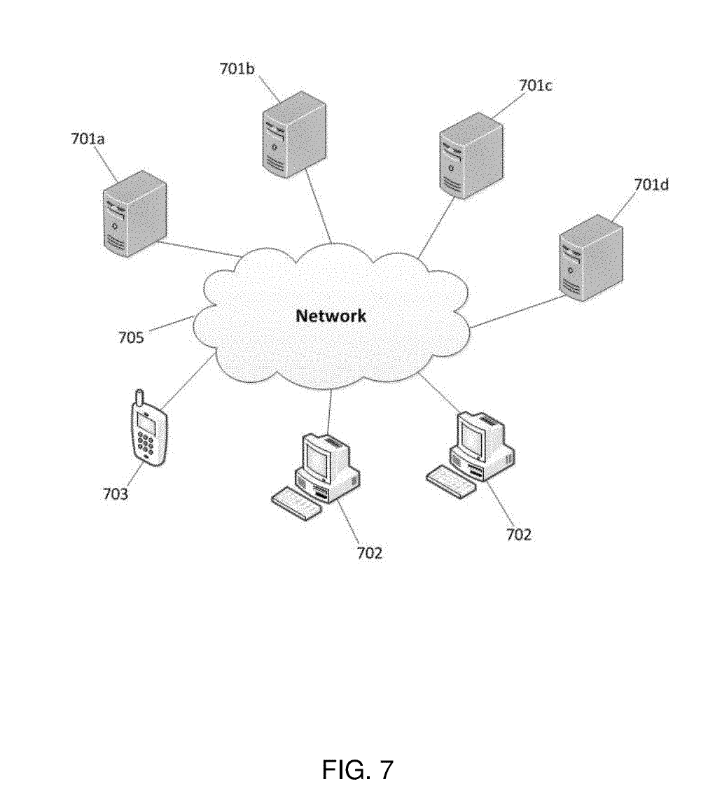

FIG. 7 is a block diagram of exemplary distributed and/or cloud-based embodiments. Although FIG. 1, and portions of the exemplary discussion above, make reference to a centralized coupon processing system 100 operating on a single computing device, one will recognize that various of the modules within the coupon processing system 100 may instead be distributed across a network 706 in separate server systems 701a-d and possibly in user systems, such as a desktop computer device 702, or mobile computer device 703. As another example, the user interface provided by the mobile application 123 can be a client side application of a client-server environment (e.g., a web browser or downloadable application, such as a mobile app), wherein the processing module 109 is hosted by one or more of the server systems 701a-d (e.g., in a cloud-based environment) and interacted with by the desktop computer device or mobile computer device. In some distributed systems, the modules of the system 100 can be separately located on server systems 701a-d and can be in communication with one another across the network 706.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An image-based acquisition system comprising:
a mobile application associated with a user account that when executed on a mobile device is configured to:
receive one or more images of one or more coupons using the mobile device,
receive one or more images of one or more receipts of previous transactions, and
transmit the one or more images of the one or more coupons and the one or more images of the one or more receipts of previous transactions over a network ;
a computing system in communication with the mobile device, the computing system configured to execute a processing module that when executed:
receives, from the mobile device the one or more images of the one or more coupons,
receives, from the mobile device the one or more images of the one or more receipts of previous transactions,
extracts from the one or more images of the one or more coupons, electronic coupon data representing a coupon code associated with each coupon,
determines whether each coupon is valid based on the electronic coupon data;
identifies one or more items in the one or more receipts of previous transactions that are associated with the one or more coupons, and
applies automatically, when the coupon is determined as a valid coupon, a credit associated with the one or more coupons to the user account based on the identified one or more items.

2. The system of claim 1 wherein a user associated with the user account is notified of the credit.

3. The system of claim 1 wherein the credit is in the form of a gift card dispensed to a user associated with the user account.

4. The system of claim 1, wherein the coupon code includes a qualified item code and a coupon redemption value, and the processing module when executed:
extracts electronic item data representing an item code associated with each item listed on a receipt associated with the user account;
determines whether the item is a qualified item based on the item data and the qualified item code included in the coupon code of each valid coupon; and
reduces a receipt total of a receipt by the coupon redemption value when the item is determined as a qualified item.

5. The system of claim 1, wherein the coupon code further includes an expiration date, and the processing module when executed determines whether the coupon is expired based on the expiration date and a current date.

6. A coupon processing system for triggering online orders comprising:
a mobile application associated with a user account that when executed on a mobile device is configured to:
receive one or more images of one or more coupons using the mobile device,
transmit the one or more images of the one or more coupons over a network;
a computing system in communication with the mobile device, the computing system configured to execute a processing module that when executed:
receives, from the mobile device the one or more images of the one or more coupons,
extracts from the one or more images of the one or more coupons, electronic coupon data representing a coupon code associated with each coupon,
determines whether each coupon is valid based on the electronic coupon data;
identifies one or more items that are associated with the one or more coupons and available for sale, and
adds automatically, when the coupon is determined as a valid coupon, the one or more items to an online order for a user associated with the user account.

7. The system of claim 6 wherein the online order is an existing order.

8. The system of claim 6 wherein the online order is a new order initiated by the computing system following a determination that no online order associated with the user account is pending.

9. The system of claim 6 wherein the user is notified of the online order additions and a value of the coupons as applied to the order through the mobile application.

10. A computer-implemented method for processing machine-readable coupons, comprising:
receiving, at a computing system executing a processing module, one or more images of one or more coupons and one or more images of one or more receipts of previous transactions from a mobile application executing on a mobile device, the mobile application associated with a user account;
extracting from the one or more images of the one or more coupons, with the processing module, electronic coupon data representing a coupon code associated with each coupon;
determining with the processing module whether each coupon is valid based on the electronic coupon data;
identifying one or more items in the one or more receipts of previous transactions that are associated with the one or more coupons with the processing module; and
applying automatically with the processing module, when the coupon is determined as a valid coupon, a credit associated with the one or more coupons to the user account based on the identified one or more items.

11. The method of claim 10 wherein a user associated with the user account is notified of the credit.

12. The method of claim 10 wherein the credit is in the form of a gift card dispensed to a user associated with the user account.

13. The method of claim 10,
wherein the coupon code includes a qualified item code and a coupon redemption value, and the processing module further:
extracts electronic item data representing an item code associated with each item listed on a receipt associated with the user account;
determines whether the item is a qualified item based on the item data and the qualified item code included in the coupon code of each valid coupon;
reduces a receipt total of a receipt by the coupon redemption value when the item is determined as a qualified item.

14. The method of claim 10, wherein the coupon code further includes an expiration date, and the processing module determines whether the coupon is expired based on the expiration date and a current date.

15. A method for triggering online orders, the method comprising:
receiving, at a computing system executing a processing module, one or more images of one or more coupons from a mobile application executing on a mobile device, the mobile application associated with a user account,
extracting from the one or more images of the one or more coupons, with the processing module, electronic coupon data representing a coupon code associated with each coupon,
determining with the processing module whether each coupon is valid based on the electronic coupon data;
identifying one or more items that are associated with the one or more coupons and available for sale with the processing module, and
adding automatically with the processing module, when the coupon is determined as a valid coupon, the one or more items to an online order for a user associated with the user account.

16. The method of claim 15 wherein the online order is an existing order.

17. The method of claim 15 wherein the online order is a new order initiated by the computing system.

18. The method of claim 15 wherein the user is notified of the online order additions and a value of the coupons as applied to the order through the mobile application.
